(19) United States
(12) Patent Application Publication
(10) Pub. No.: US 2020/0099495 A1
(43) Pub. Date: Mar. 26, 2020

(54) FTM PROTOCOL ENHANCEMENTS TO ANNOUNCE ACKNOWLEDGEMENT MCS RATE

(71) Applicant: QUALCOMM Incorporated, San Diego, CA (US)

(72) Inventors: Xiaoxin Zhang, Sunnyvale, CA (US); Sunil Ravi, Sunnyvale, CA (US); Kurt Erwin Landenberger, Santa Clara, CA (US); Alireza Raissinia, Monte Sereno, CA (US)

(21) Appl. No.: 16/267,822

(22) Filed: Feb. 5, 2019

Related U.S. Application Data
(60) Provisional application No. 62/734,404, filed on Sep. 21, 2018.

(51) Int. Cl. H04L 5/00; H04L 27/26

(52) U.S. Cl. CPC H04L 5/0055; H04W 84/12; H04L 27/2601

(57) ABSTRACT

In some implementations, an apparatus transmits information indicating a modulation and coding scheme (MCS) table for transmitting non-legacy acknowledgement (ACK) frames during a ranging operation to a responder device, receives a ranging frame including an indication of whether the responder device is capable of supporting the indicated MCS table, and transmits to the responder device an ACK frame using an MCS that is based on the capability of the responder device to support the MCS table. In other implementations, the apparatus receives from an initiator device information indicating an MCS table for transmitting non-legacy ACK frames during the ranging operation, transmits a ranging frame including an indication of whether the apparatus is capable of supporting the indicated MCS table, and receives from the initiator device an ACK frame transmitted using an MCS that is based on the capability of the apparatus to support the MCS table.

### CROSS-REFERENCE TO RELATED APPLICATIONS

This Patent Application claims priority under 35 U.S.C. 119 to U.S. Provisional Patent Application No. 62/734,404 entitled “FTM PROTOCOL ENHANCEMENTS TO ANNOUNCE ACKNOWLEDGEMENT MCS RATE” filed on Sep. 21, 2018, which is assigned to the Assignee of this Patent Application. The disclosures of all prior Applications are considered part of and are incorporated by reference in this Patent Application.

### TECHNICAL FIELD

This disclosure relates generally to wireless devices, and specifically to ranging operations between wireless devices.

### DESCRIPTION OF THE RELATED TECHNOLOGY

The proliferation of Wi-Fix access points in wireless local area networks (WLANs) has made it possible for positioning systems to use these access points for position determination, especially in areas where there is a large concentration of active Wi-Fi access points (such as urban cores, shopping centers, office buildings, sporting venues, and so on). For example, a wireless device such as a cell phone or tablet computer may use the round trip time (RTT) of signals exchanged with an access point (AP) to determine the distance between the wireless device and the AP. Once the distances between the wireless device and three APs having known locations are determined, the location of the wireless device may be determined using trilateration techniques.

Some wireless devices may use the fine timing measurement (FTM) protocol defined by the IEEE 802.11REVmc specification to exchange a number of measurement frames (such as FTM frames and ACK frames) during ranging operations. The FTM protocol may allow the FTM frames to be transmitted using a high-throughput (HT) format, a very high-throughput (VHT) format, a high-efficiency (HE) format, or a legacy format (such as a non-HT format), and may allow the ACK frames to be transmitted using the HT format, the VHT format, the HE format, or the non-HT format. The FTM protocol may also allow the FTM frames to be transmitted using an extremely high throughput (EHT) format.

### SUMMARY

The systems, methods and devices of this disclosure each have several innovative aspects, no single one of which is solely responsible for the desirable attributes disclosed herein.

One innovative aspect of the subject matter described in this disclosure can be implemented as a method for performing a ranging operation between an initiator device and a responder device. In some implementations, the method may be performed by the initiator device and may include transmitting information indicating a modulation and coding scheme (MCS) table for transmitting non-legacy acknowledgement (ACK) frames to the responder device during the ranging operation, receiving a ranging frame including an indication of whether the responder device is capable of supporting the MCS table, and transmitting to the responder device an ACK frame using an MCS that is based on the capability of the responder device to support the MCS table. In some implementations, the ranging frame may be a first fine timing measurement (FTM) frame that includes a capability element indicating whether the responder device is capable of supporting an MCS table defined by a wireless communication standard or is capable of supporting a non-standardized MCS table. In addition, or in the alternative, the initiator device may receive from the responder device a second FTM frame including timing information of the first FTM frame and the ACK frame.

In some implementations, the MCS table may be transmitted to the responder device in a fine timing measurement (FTM) request frame. The FTM request frame may indicate that the initiator device is to transmit legacy ACK frames during a first FTM burst, and is to transmit non-legacy ACK frames during subsequent FTM bursts. In addition, or in the alternative, the FTM request frame may include an announcement element including a capability field indicating whether the MCS table is defined by a wireless communication standard or is a non-standardized MCS table. In some implementations, the capability field may indicate whether the announcement element includes the non-standardized MCS table. The announcement element may also include a plurality of MCS tables, and each of the MCS tables may correspond to a respective one of a plurality of different ACK frame formats. In some implementations, a respective MCS table may include a plurality of MCS values each based on a corresponding MCS used by the responder device to transmit FTM frames during the ranging operation.

Another innovative aspect of the subject matter described in this disclosure can be implemented in an apparatus for performing a ranging operation with a responder device. The apparatus may include one or more processors and a memory. In some implementations, the memory may include instructions that, when executed by the one or more processors, cause the apparatus to transmit information indicating a modulation and coding scheme (MCS) table for transmitting non-legacy acknowledgement (ACK) frames to the responder device during the ranging operation, receive a ranging frame including an indication of whether the responder device is capable of supporting the MCS table, and transmit to the responder device an ACK frame using an MCS that is based on the capability of the responder device to support the MCS table. In some implementations, the ranging frame may be a first fine timing measurement (FTM) frame that includes a capability element indicating whether the responder device is capable of supporting an MCS table defined by a wireless communication standard or is capable of supporting a non-standardized MCS table. In addition, or in the alternative, the apparatus may receive from the responder device a second FTM frame including timing information of the first FTM frame and the ACK frame.

In some implementations, the MCS table may be transmitted to the responder device in a fine timing measurement (FTM) request frame. The FTM request frame may indicate that the apparatus is to transmit legacy ACK frames during a first FTM burst, and is to transmit non-legacy ACK frames during subsequent FTM bursts. In addition, or in the alternative, the FTM request frame may include an announcement element including a capability field indicating whether the MCS table is defined by a wireless communication standard or is a non-standardized MCS table. In some implementations, the capability field may indicate whether the announcement element includes the non-standardized MCS table. The announcement element also may include a plurality of MCS tables, and each of the MCS tables may correspond to a respective one of a plurality of different ACK frame formats. In some implementations, a respective MCS table may include a plurality of MCS values each based on a corresponding MCS used by the responder device to transmit FTM frames during the ranging operation.

Another innovative aspect of the subject matter described in this disclosure can be implemented as a method for performing a ranging operation between an initiator device and a responder device. In some implementations, the method may be performed by the responder device and may include receiving, from the initiator device, information indicating a modulation and coding scheme (MCS) table for transmitting non-legacy acknowledgement (ACK) frames during the ranging operation, transmitting to the initiator device a ranging frame including an indication of whether the responder device is capable of supporting the MCS table, and receiving from the initiator device an ACK frame transmitted using an MCS that is based on the capability of the responder device to support the MCS table. In some implementations, the ranging frame may be a first fine timing measurement (FTM) frame that includes a capability element indicating whether the responder device is capable of supporting an MCS table defined by a wireless communication standard or is capable of supporting a non-standardized MCS table. In addition, or in the alternative, the responder device may transmit to the initiator device a second FTM frame including timing information of the first FTM frame and the ACK frame.

In some implementations, the MCS table may be received from initiator device in a fine timing measurement (FTM) request frame. The FTM request frame may indicate that the initiator device is to transmit legacy ACK frames during a first FTM burst, and is to transmit non-legacy ACK frames during subsequent FTM bursts. In addition, or in the alternative, the FTM request frame may include an announcement element including a capability field indicating whether the MCS table is defined by a wireless communication standard or is a non-standardized MCS table. In some implementations, the capability field may indicate whether the announcement element includes the non-standardized MCS table. The announcement element may also include a plurality of MCS tables, and each of the MCS tables may correspond to a respective one of a plurality of different ACK frame formats. In some implementations, a respective MCS table may include a plurality of MCS values each based on a corresponding MCS used by the responder device to transmit FTM frames during the ranging operation.

Another innovative aspect of the subject matter described in this disclosure can be implemented in an apparatus for performing a ranging operation with an initiator device. The apparatus may include one or more processors and a memory. In some implementations, the memory may include instructions that, when executed by the one or more processors, cause the apparatus to receive, from the initiator device, information indicating a modulation and coding scheme (MCS) table for transmitting non-legacy acknowledgement (ACK) frames during the ranging operation, transmit to the initiator device a ranging frame including an indication of whether the apparatus is capable of supporting the MCS table, and receive from the initiator device an ACK frame transmitted using an MCS that is based on the capability of the apparatus to support the MCS table. In some implementations, the ranging frame may be a first fine timing measurement (FTM) frame that includes a capability element indicating whether the apparatus is capable of supporting an MCS table defined by a wireless communication standard or is capable of supporting a non-standardized MCS table. In addition, or in the alternative, the apparatus may transmit to the initiator device a second FTM frame including timing information of the first FTM frame and the ACK frame.

In some implementations, the MCS table may be transmitted to the apparatus in a fine timing measurement (FTM) request frame. The FTM request frame may indicate that the initiator device is to transmit legacy ACK frames during a first FTM burst, and is to transmit non-legacy ACK frames during subsequent FTM bursts. In addition, or in the alternative, the FTM request frame may include an announcement element including a capability field indicating whether the MCS table is defined by a wireless communication standard or is a non-standardized MCS table. In some implementations, the capability field may indicate whether the announcement element includes the non-standardized MCS table. The announcement element may also include a plurality of MCS tables, and each of the MCS tables may correspond to a respective one of a plurality of different ACK frame formats. In some implementations, a respective MCS table may include a plurality of MCS values each based on a corresponding MCS used by the responder device to transmit FTM frames during the ranging operation.

### BRIEF DESCRIPTION OF THE DRAWINGS

FIG. 1 shows a block diagram of an example wireless system.

FIG. 2 shows a block diagram of an example access point.

FIG. 3 shows a block diagram of an example wireless station.

FIG. 4 shows a signal diagram of an example ranging operation.

FIG. 5 shows a signal diagram of another example ranging operation.

FIG. 6A shows a flow chart depicting an example ranging operation.

FIG. 6B shows a flow chart depicting an example operation for exchanging measurement frames for the ranging operation of FIG. 6A.

FIG. 7A shows a flow chart depicting another example ranging operation.

FIG. 7B shows a flow chart depicting an example operation for exchanging measurement frames for the ranging operation of FIG. 7A.

FIG. 8 shows an example Modulation and Coding Scheme (MCS)

Table.

FIG. 9A shows an example fine timing measurement (FTM) request frame.

FIG. 9B shows an example FTM frame.

FIG. 10A shows an example MCS Table Announcement Element.

FIG. 10B shows an example MCS Table Field.

FIG. 11 shows an example MCS Capability Element.

FIG. 12 shows an example ACK frame.

FIG. 13A shows an example legacy preamble of a packet.

FIG. 13B shows an example preamble of a high-throughput (HT) packet.

FIG. 13C shows an example preamble of a very high-throughput (VHT) packet.

FIG. 13D shows an example preamble of a high-efficiency (HE) packet.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the IEEE 802.11 standards, or any of the IEEE 802.15 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Implementations of the subject matter described in this disclosure may increase the accuracy of ranging operations performed between wireless devices by allowing the wireless devices to announce or to negotiate the MCS for transmitting frames to each other during the ranging operation. In some implementations, an initiator device may transmit information indicating a modulation and coding scheme (MCS) table for transmitting non-legacy acknowledgement (ACK) frames to the responder device during the ranging operation. In some aspects, the MCS table may be defined by a wireless communication standard (such as the IEEE 802.11 standards). In other aspects, the MCS table may be a non-standardized MCS table (such as a proprietary MCS table). The responder device may receive the information, and may indicate whether the responder device is capable of supporting the MCS table. In some aspects, the responder device may also indicate whether the responder device is capable of supporting the standard MCS table defined by the wireless communication standard or is capable of supporting the non-standardized MCS table (such as proposed by the initiator device).

Particular implementations of the subject matter described in this disclosure can be implemented to realize one or more of the following potential advantages. Implementations of the subject matter disclosed herein may improve the accuracy with which wireless devices perform or measure ranging operations by ensuring that each of the wireless devices is informed of the MCS or the frame format (or both) that will be used for transmitting frames to each other. In some implementations, a first wireless device may announce or share a selected MCS that will be used for transmitting frames to other wireless devices during a ranging operation. Other wireless devices that receive the announcement or selected MCS may use the selected MCS to decode frames received from the first wireless device and to determine packet length information of the received frames. In implementations for which time of arrival (TOA) values of the received frames are based at least in part on the determined packet length information, knowledge of the MCS used by the first wireless device may improve the accuracy of the determined packet length information, which in turn may increase the accuracy of round-trip time (RTT) values calculated by one or more of the wireless devices.

In some other implementations, the first wireless device may announce an MCS table containing a number of MCS values from which one is selected for transmitting frames during the ranging operation. In some aspects, the selected MCS may correspond to the MCS with which a second wireless device transmits frames to the first wireless device during the ranging operation. In some other implementations, the first wireless device may announce a plurality MCS tables, and each of the MCS tables may include a number of MCS values associated with a corresponding one of a plurality of different frame formats. In this manner, wireless devices associated with the ranging operation may use the same MCS, irrespective of the particular frame format.

In some implementations, the first wireless device may negotiate, with other wireless devices, the MCS that will be used for transmitting frames to the other wireless devices for each of a plurality of different frame formats. The negotiation may ensure that the wireless devices transmit frames to each other using the same frame format (such as the most recent frame format adopted by the IEEE 802.11 standards), which may also improve ranging accuracy. In addition, or in the alternative, the first wireless device may announce or negotiate a number of custom, proprietary, or other non-standardized MCS values to be used for the ranging operation. The ability of wireless devices to use non-standardized MCS values for transmitting frames to each other during the ranging operation may increase ranging accuracy, for example, when the non-standardized MCS values are better-suited for a particular ranging operation than standardized MCS values.

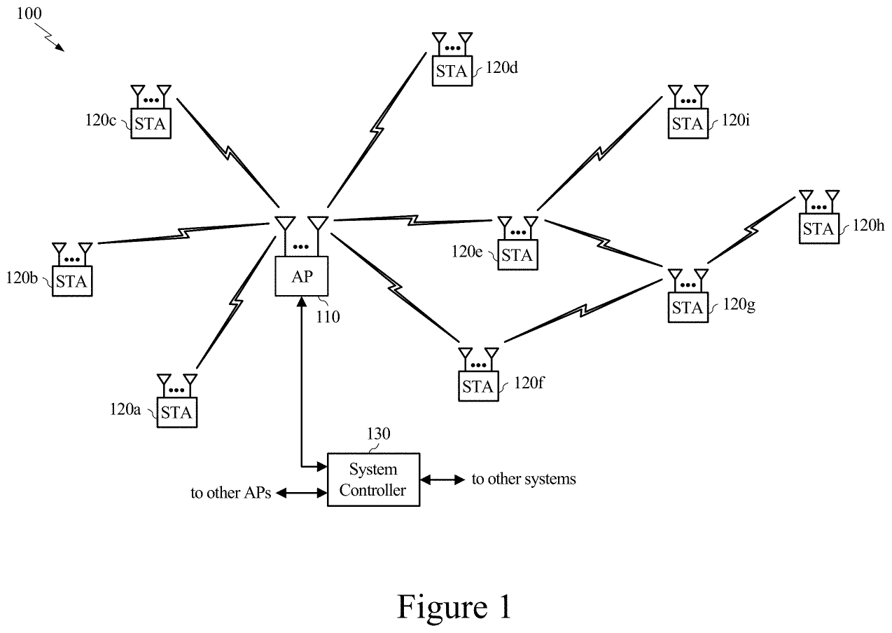

FIG. 1 shows a block diagram of an example wireless system 100. The wireless system 100 is shown to include a wireless access point (AP) 110 and a number of wireless stations (STAs) 120a-120i. For simplicity, only one AP 110 is shown in FIG. 1. The AP 110 may form a wireless local network (WLAN) that allows the AP 110, the STAs 120a-120i, and other wireless devices (not shown for simplicity) to communicate with each other over a wireless medium. The wireless medium, which may be divided into a number of channels or into a number of resource units (RUs), may facilitate wireless communications between the AP 110, the STAs 120a-120i, and other wireless devices connected to the WLAN. In some aspects, the STAs 120a-120i can communicate with each other using peer-to-peer communications (such as without the presence or involvement of the AP 110). The AP 110 may be assigned a unique medium access control (MAC) address that is programmed therein by, for example, the manufacturer of the access point. Similarly, each of the STAs 120a-120i also may be assigned a unique MAC address.

In some implementations, the wireless system 100 may correspond to a multiple-input multiple-output (MIMO) wireless network, and may support single-user MIMO (SU-MIMO) and multi-user (MU-MIMO) communications. In some aspects, the wireless system 100 may support orthogonal frequency-division multiple access (OFDMA) communications. Further, although the WLAN is depicted in FIG. 1 as an infrastructure Basic Service Set (BSS), in some other implementations, the WLAN may be an Independent Basic Service Set (IBSS), an Extended Service Set (ESS), an ad-hoc network, or a peer-to-peer (P2P) network (such as operating according to one or more Wi-Fi Direct protocols).

The STAs 120a-120i may be any suitable Wi-Fi enabled wireless devices including, for example, cell phones, personal digital assistants (PDAs), tablet devices, laptop computers, or the like. The STAs 120a-120i also may be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The AP 110 may be any suitable device that allows one or more wireless devices (such as the STAs 120a-120i) to connect to another network (such as a local area network (LAN), wide area network (WAN), metropolitan area network (MAN), or the Internet). In some implementations, a system controller 130 may facilitate communications between the AP 110 and other networks or systems, and also may facilitate communications between the AP 110 and one or more other APs (not shown for simplicity) that may be associated with other wireless networks. In addition, or in the alternative, the AP 110 may exchange signals and information with one or more other APs using wireless communications.

The AP 110 may periodically broadcast beacon frames to enable the STAs 120a-120i and other wireless devices within wireless range of the AP 110 to establish and maintain a communication link with the AP 110. The bacon frames may be broadcast according to a target beacon transmission time (TBTT) schedule, and may include the timing synchronization function (TSF) value of the AP 110. The STAs 120a-120i may synchronize their own local TSF values with the broadcasted TSF value, for example, so that all the STAs 120a-120i are synchronized with each other and the AP 110. In some implementations, the beacon frames may indicate downlink (DL) data transmissions to the STAs 120a-120i and solicit or schedule uplink (UL) data transmissions from the STAs 120a-120i. In addition, or in the alternative, one or more of the beacon frames may include or announce a ranging schedule indicating times and channels upon which the AP 110 is to either initiate or respond to ranging operations.

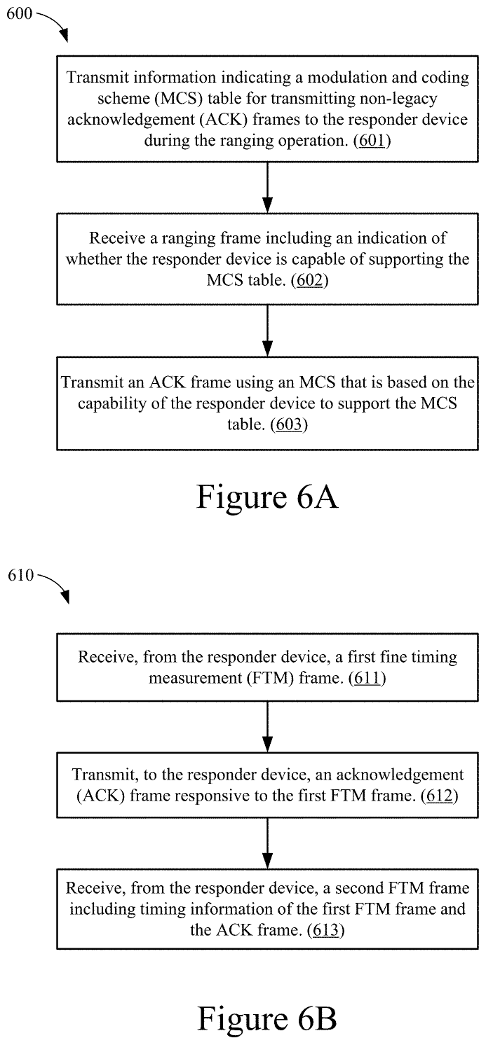

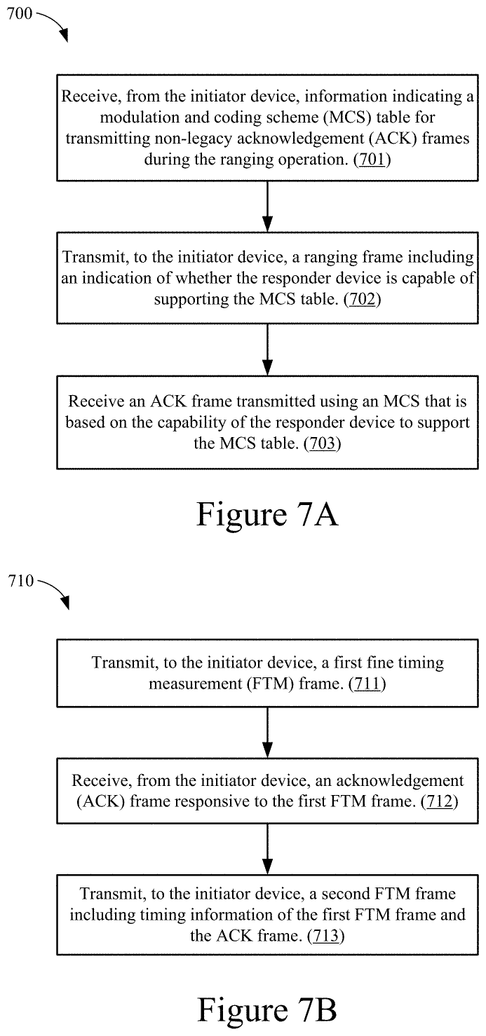

In some implementations, each of the stations STAs 120a-120i and the AP 110 may include one or more transceivers, one or more processing resources (such as processors or Application-Specific Integrated Circuits (ASICs)), one or more memory resources, and a power source (such as a battery). The one or more transceivers may include Wi-Fi transceivers, Bluetooth transceivers, cellular transceivers, or other suitable radio frequency (RF) transceivers (not shown for simplicity) to transmit and receive wireless communication signals. In some aspects, each transceiver may communicate with other wireless devices in distinct frequency bands or using distinct communication protocols. The memory resources may include a non-transitory computer-readable medium (such as one or more nonvolatile memory elements, such as EPROM, EEPROM, Flash memory, a hard drive, etc.) that stores instructions for performing one or more operations described with respect to FIGS. 6A-6B and FIGS. 7A-7B.

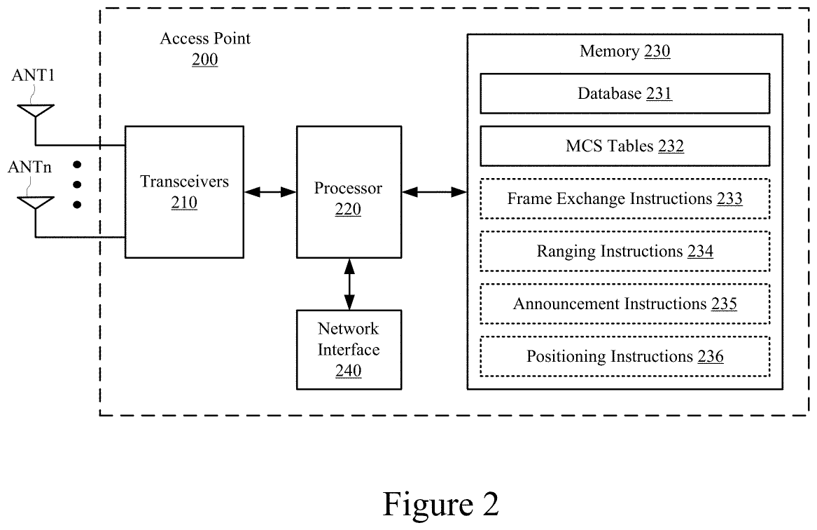

FIG. 2 shows an example access point (AP) 200. The AP 200 may be one implementation of the AP 110 of FIG. 1. The AP 200 may include one or more transceivers 210, a processor 220, a memory 230, a network interface 240, and a number of antennas ANT1-ANTn. The transceivers 210 may be coupled to antennas ANT1-ANTn, either directly or through an antenna selection circuit (not shown for simplicity). The transceivers 210 may be used to transmit signals to and receive signals from other wireless devices including, for example, one or more of the STAs 120a-120i of FIG. 1 and other APs. Although not shown in FIG. 2 for simplicity, the transceivers 210 may include any number of transmit chains to process and transmit signals to other wireless devices via antennas ANT1-ANTn, and may include any number of receive chains to process signals received from antennas ANT1-ANTn. In some implementations, the AP 200 may be configured for MIMO communications and OFDMA communications. The MIMO communications may include SU-MIMO communications and MU-MIMO communications. In some implementations, the AP 200 may use multiple antennas ANT1-ANTn to provide antenna diversity. Antenna diversity may include polarization diversity, pattern diversity, and spatial diversity.

The network interface 240, which is coupled to the processor 220, may be used to communicate with the system controller 130 of FIG. 1. The network interface 240 also may allow the AP 200 to communicate, either directly or via one or more intervening networks, with other wireless systems, with other APs, with one or more back-haul networks, and so on.

The memory 230 may include a database 231 that may store location data, configuration information, data rates, MAC addresses, timing information, modulation and coding schemes, ranging capabilities, and other suitable information about (or pertaining to) a number of other wireless devices. In some implementations, database 231 also may store profile information for a number of wireless stations (STAs). The profile information for a given STA may include, for example, a service set identification (SSID) of the STA, operating channels, received signal strength indicator (RSSI) values, goodput values, connection history with the AP 200, and previous ranging operations with the AP 200.

The memory 230 may also include or store a number of MCS tables 232. Each of the MCS tables 232 may include or specify an MCS to be used by an initiator device when transmitting frames (such as ACK frames) to a responder device during a ranging operation (such as an FTM protocol ranging operation) for each of a number of MCS values to be used by the responder device when transmitting frames (such as FTM frames) to the initiator device. In some implementations, each of the MCS tables 232 may correspond to a respective one of a plurality of different frame formats. In some aspects, the plurality of different frame formats may include an HT frame format, a VHT frame format, an HE frame format, and a legacy frame format. In addition, or in the alternative, the plurality of different frame formats may include an EHT frame format.

The memory 230 may also include a non-transitory computer-readable storage medium (such as one or more nonvolatile memory elements, such as EPROM, EEPROM, Flash memory, a hard drive, and so on) that may store the following programs or instructions:
frame exchange instructions 233 to create and exchange ranging frames (such as request frames, response frames, measurement frames, and feedback frames) and other frames (such as data frames, control frames, and management frames) between the AP 200 and other wireless devices (such as a STA or another AP), for example, as described with respect to FIGS. 6A-6B and FIGS. 7A-7B;
ranging instructions 234 to negotiate and perform ranging operations with other wireless devices, for example, as described with respect to FIGS. 6A-6B and FIGS. 7A-7B;
announcement instructions 235 to announce or negotiate the MCS used by the AP 200 to transmit ACK frames during ranging operations (such as when the AP 200 operates as the initiator device), for example, as described with respect to FIGS. 6A-6B and FIGS. 7A-7B; and
positioning instructions 236 to determine the location of one or more other wireless devices and to share location information of the AP 200 with other wireless devices, as described with respect to FIGS. 6A-6B and FIGS. 7A-7B.
   Execution of each set of instructions 233-236 by the processor 220 may cause the AP 200 to perform the corresponding functions. The non-transitory computer-readable medium of the memory 230 thus includes instructions for performing all or a portion of the operations described with respect to FIGS. 6A-6B and FIGS. 7A-7B.

The processor 220 may be any one or more suitable processors capable of executing scripts or instructions of one or more software programs stored in the AP 200 (such as within the memory 230). The processor 220 may execute the frame exchange instructions 233 to create and exchange ranging frames (such as request frames, response frames, measurement frames, and feedback frames) and other frames (such as data frames, control frames, and management frames) between the AP 200 and other wireless devices (such as a STA or another AP). In some implementations, the ranging frames may include measurement frames defined by the FTM protocol.

The processor 220 may execute the ranging instructions 234 to negotiate and perform ranging operations with other wireless devices. In some implementations, the processor 220 may execute the ranging instructions 234 to capture or record timestamps of signals received by the AP 200 (such as TOA information) and timestamps of signals transmitted from the AP 200 (such as TOD information), and to estimate angle information of frames exchanged with other wireless devices. The angle information may include angle-of-arrival (AoA) and angle-of-departure (AoD) information.

The processor 220 may execute the announcement instructions 235 to announce the MCS table to be used to transmit ACK frames during ranging operations (such as when the AP 200 operates as the initiator device), and may execute the announcement instructions 235 to indicate whether the AP 200 is capable of supporting the MCS table to be used or proposed by another ranging device (such as when the AP 200 operates as the responder device). In addition, or in the alternative, the processor 220 may execute the announcement instructions 235 to negotiate the MCS to be used for transmitting frames exchanged between the AP 200 and one or more other wireless devices during ranging operations.

The processor 220 may execute the positioning instructions 236 to determine the location of one or more other wireless devices and to share location information of the AP 200 and possibly location of other APs in the vicinity with other wireless devices.

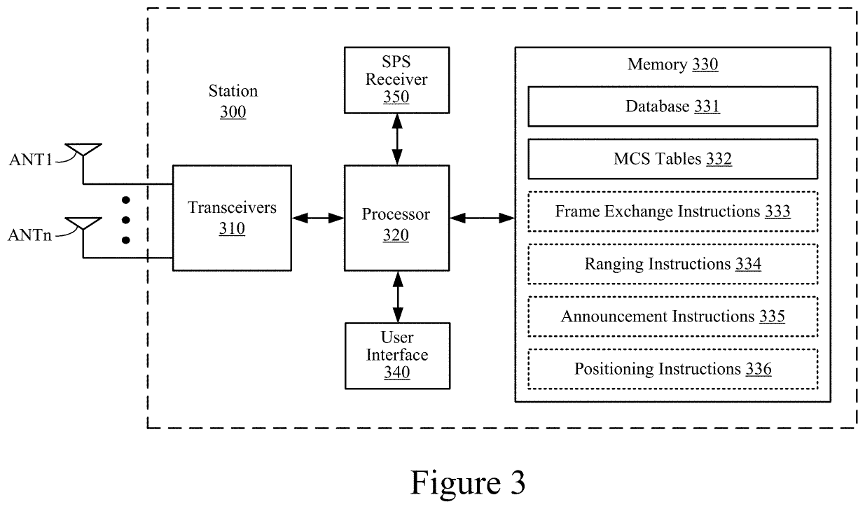

FIG. 3 shows an example wireless station (STA) 300. The STA 300 may be one implementation of at least one of the STAs 120a-120i of FIG. 1. The STA 300 may include one or more transceivers 310, a processor 320, a memory 330, a user interface 340, and a number of antennas ANT1-ANTn. The transceivers 310 may be coupled to antennas ANT1-ANTn, either directly or through an antenna selection circuit (not shown for simplicity). The transceivers 310 may be used to transmit signals to and receive signals from other wireless devices including, for example, a number of APs and a number of other STAs. Although not shown in FIG. 3 for simplicity, the transceivers 310 may include any number of transmit chains to process and transmit signals to other wireless devices via antennas ANT1-ANTn, and may include any number of receive chains to process signals received from antennas ANT1-ANTn. Thus, the STA 300 may be configured for MIMO communications and OFDMA communications. The MIMO communications may include SU-MIMO communications and MU-MIMO communications. Further, in some aspects, the STA 300 may use multiple antennas ANT1-ANTn to provide antenna diversity. Antenna diversity may include polarization diversity, pattern diversity, and spatial diversity.

The user interface 340, which is coupled to the processor 320, may be or represent a number of suitable user input devices such as, for example, a speaker, a microphone, a display device, a keyboard, a touch screen, and so on. In some implementations, the user interface 340 may allow a user to control a number of operations of the STA 300, to interact with one or more applications executable by the STA 300, and other suitable functions. In some aspects, the user interface 340 may be or may include a touch-sensitive display that can display information to a user and that can receive touch or gesture inputs from the user.

In some implementations, the STA 300 may include a satellite positioning system (SPS) receiver 350. The SPS receiver 350, which is coupled to the processor 320, may be used to acquire and receive signals transmitted from one or more satellites or satellite systems via an antenna (not shown for simplicity). Signals received by the SPS receiver 350 may be used to determine (or at least assist with the determination of) a location of the STA 300.

The memory 330 may include a database 331 that may store location data, configuration information, data rates, MAC addresses, timing information, modulation and coding schemes, ranging capabilities, and other suitable information about (or pertaining to) a number of other wireless devices. In some implementations, the database 331 also may store profile information for a number of APs. The profile information for a given AP may include, for example, the AP's basic service set identification (BSSID), operating channels, beacon intervals, ranging schedules, channel state information (C SI), RSSI values, goodput values, and previous ranging operations with the STA 300.

The memory 330 may also include or store a number of MCS tables 332. Each of the MCS tables 232 may include or specify an MCS to be used by an initiator device when transmitting frames (such as ACK frames) to a responder device during a ranging operation (such as an FTM protocol ranging operation) for each of a plurality of MCS values to be used by the responder device when transmitting frames (such as FTM frames) to the initiator device. In some implementations, each of the MCS tables 232 may correspond to a respective one of a plurality of different frame formats. In some aspects, the plurality of different frame formats may include an HT frame format, a VHT frame format, an HE frame format, and a legacy frame format. In addition, or in the alternative, the plurality of different frame formats may include an EHT frame format.

The memory 330 also may include a non-transitory computer-readable storage medium (such as one or more nonvolatile memory elements, such as EPROM, EEPROM, Flash memory, a hard drive, and so on) that may store the following instructions:
frame exchange instructions 333 to create and exchange ranging frames (such as request frames, response frames, measurement frames, and feedback frames) and other frames (such as data frames, control frames, and management frames) between the STA 300 and other wireless devices, for example, as described with respect to FIGS. 6A-6B and FIGS. 7A-7B;
ranging instructions 334 to negotiate and perform ranging operations with other wireless devices (such as an AP or another STA), for example, as described with respect to FIGS. 6A-6B and FIGS. 7A-7B;
announcement instructions 335 to announce or negotiate the MCS used by the STA 300 to transmit ACK frames during ranging operations (such as when the STA 300 operates as the initiator device), for example, as described with respect to FIGS. 6A-6B and FIGS. 7A-7B; and
positioning instructions 336 to determine the location of the STA 300 and to share location information of the STA 300 with other wireless devices, for example, as described with respect to FIGS. 6A-6B and FIGS. 7A-7B.
   Execution of each set of instructions 333-336 by the processor 320 may cause the STA 300 to perform the corresponding functions. The non-transitory computer-readable medium of the memory 330 thus includes instructions for performing all or a portion of the operations described with respect to FIGS. 6A-6B and FIGS. 7A-7B.

The processor 320 may be any one or more suitable processors capable of executing scripts or instructions of one or more software programs stored in the STA 300 (such as within the memory 330). The processor 320 may execute the frame exchange instructions 333 to create and exchange ranging frames (such as request frames, response frames, measurement frames, and feedback frames) and other frames (such as data frames, control frames, and management frames) between the STA 300 and other wireless devices (such as an AP or another STA). In some implementations, the ranging frames may include measurement frames defined by the FTM protocol.

The processor 320 may execute the ranging instructions 334 to negotiate and perform ranging operations with other wireless devices. In some implementations, the processor 320 may execute the ranging instructions 334 to capture or record timestamps of signals received by the STA 300 (such as TOA information) and timestamps of signals transmitted from the STA 300 (such as TOD information), and to estimate angle information of frames exchanged with other wireless devices (such as AoA information and AoD information).

The processor 320 may execute the announcement instructions 335 to announce the MCS table to be used to transmit ACK frames during ranging operations (such as when the STA 300 operates as the initiator device), and may execute the announcement instructions 335 to indicate whether the STA 300 is capable of supporting the MCS table to be used or proposed by another ranging device (such as when the STA 300 operates as the responder device). In addition, or in the alternative, the processor 320 may execute the announcement instructions 335 to negotiate the MCS to be used for transmitting frames exchanged between the STA 300 and one or more other wireless devices during ranging operations.

The processor 320 may execute the positioning instructions 336 to capture timestamps or estimate time of arrival (TOA) and time of departure (TOD) information of frames exchanged during ranging operations, and to determine the location of the STA 300 based on TOA values, TOD values, RTT estimates, angle information, or any combination thereof.

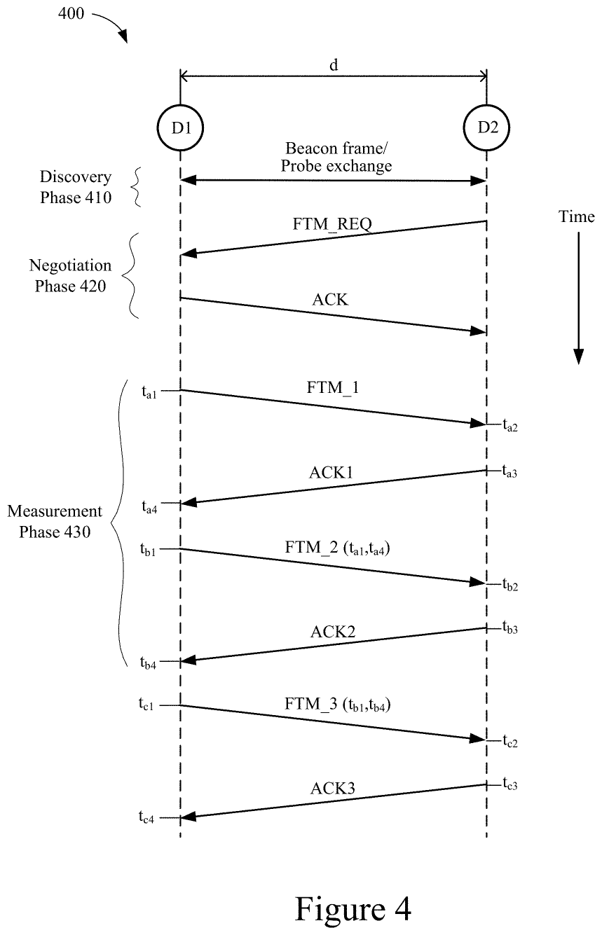

FIG. 4 shows a signal diagram of an example ranging operation 400. The example ranging operation 400 is performed between a first device D1 and a second device D2 using Fine Timing Measurement (FTM) frames in accordance with the IEEE 802.11REVmc standards. The first device D1 and the second device D2 each may be, for example, an access point (such as the AP 110 of FIG. 1 or the AP 200 of FIG. 2), a station (such as one of the STAs 120a-120i of FIG. 1 or the STA 300 of FIG. 3), or other suitable wireless device. For the example of FIG. 4, the second device D2 requests the ranging operation 400 and may be referred to as the initiator device. The first device D1 responds to the request from the second device D2, and may be referred to as the responder device.

The ranging operation 400 may include a discovery phase 410, a negotiation phase 420, and a measurement phase 430. During the discovery phase 410, the second device D2 may discover other wireless devices, within range of the second device D2, that support ranging operations. In some implementations for which the first device D1 is an AP and the second device D2 is a STA, the second device D2 may discover the first device D1 in an active manner, for example, by transmitting a probe request to the first device D1. The first device D1 may respond by transmitting a probe response that indicates whether the first device D1 supports FTM ranging operations. In other implementations, the second device D2 may discover the first device D1 in a passive manner, for example, by receiving a beacon frame from the first device D1. The beacon frame may indicate whether the first device D1 supports FTM ranging operations. In some other implementations, the second device D2 may discover the first device D1 using out-of-band signaling such as, for example, Bluetooth Low Energy (BLE) messages.

During the negotiation phase 420, the first device D1 and the second device D2 may exchange information and negotiate a number of ranging parameters and capabilities such as, for example, a capability of capturing timestamping, a capability of estimating angle information, a frame format to be used for exchanging ranging frames, a bandwidth with which to transmit ranging frames, a duration of the ranging operation, a periodicity of the ranging operation, the number of frame exchanges or “bursts” for each ranging operation, and so on.

The second device D2 may initiate the negotiation phase 420 by transmitting an FTM request (FTM_REQ) frame to the first device D1. In some implementations, the FTM_REQ frame may include a request for ranging parameters and capabilities of the first device D1, may include a request for the first device D1 to capture timestamps (such as TOA information) of received frames and to capture timestamps (such as TOD information) of transmitted frames, or both. The first device D1 receives the FTM_REQ frame, and may acknowledge the requested ranging operation by transmitting an acknowledgement (ACK) frame to the second device D2. The ACK frame may indicate the first device D1's capabilities (such as whether the first device D1 is capable of capturing timestamps, whether the first device D1 is capable of transmitting in the requested frame format and bandwidth, and so on), and may accept a number of the ranging parameters requested by the second device D2.

During the measurement phase 430, the first device D1 and the second device D2 may exchange a number of frames from which one or more RTT values can be obtained or determined. If both the first device D2 and the second device D2 support the FTM protocol, then the measurement phase 430 may be performed by exchanging a number of FTM frames and ACK frames between the first device D1 and the second device D2. As used herein, the terms “ranging frames” or “measurement frames” may refer to FTM frames and ACK frames exchanged between wireless devices according to the FTM protocol defined by the IEEE 802.11REVmc standards.

At time tₐ₁, the first device D1 transmits a first FTM (FTM_1) frame to the second device D2, and may capture the TOD of the FTM_1 frame as time tₐ₁. The second device D2 receives the FTM_1 frame at time tₐ₂, and may capture the TOA of the FTM_1 frame as time tₐ₂. The second device D2 responds by transmitting a first acknowledgement (ACK1) frame to the first device D1 at time tₐ₃, and may capture the TOD of the ACK1 frame as time tₐ₃. The first device D1 receives the ACK1 frame at time tₐ₄, and may capture the TOA of the ACK1 frame at time tₐ₄. At time t_{b1}, the first device D1 transmits (to the second device D2) a second FTM (FTM_2) frame that includes timing information indicative of timestamps captured at times tₐ₁ and tₐ₄ (such as the TOD of the FTM_1 frame and the TOA of the ACK1 frame). The second device D2 receives the FTM_2 frame at time t_{b2}, and may capture its timestamp as time t_{b2}.

Upon receiving the FTM_2 frame at time t_{b2}, the second device D2 has timing information for times tₐ₁, tₐ₂, tₐ₃, and tₐ₄ that correspond to the TOD of the FTM_1 frame transmitted from the first device D1, the TOA of the FTM_1 frame received at the second device D2, the TOD of the ACK1 frame transmitted from the second device D2, and the TOA of the ACK1 frame received at the first device D1, respectively. Thereafter, the second device D2 may determine a first RTT value as RTT₁=(tₐ₄−tₐ₃)+(tₐ₂−tₐ₁). Because the value of RTT₁ does not involve estimating SIFS for either the first device D1 or the second device D2, the value of RTT₁ does not involve errors resulting from uncertainties of SIFS durations, thereby improving the accuracy with which the distance between the first device D1 and the second device D2 may be determined (such as compared to ranging operations that rely upon or estimate processing delays within the first device D1 or the second device D2).

The first device D1 and the second device D2 may exchange an additional pair of FTM and ACK frames from which an additional RTT value may be determined. Specifically, at time t_{b3}, the second device D2 may transmit a second acknowledgement (ACK2) frame to the first device D1 (such as to acknowledge reception of the FTM_2 frame). The first device D1 receives the ACK2 frame at time t_{b4}, and may record the TOA of the ACK2 frame as time t_{b4}. At time t_{c1}, the first device D1 transmits (to the second device D2) a third FTM (FTM_3) frame that includes timing information indicative of timestamps captured at times t_{b1} and t_{b4} (such as the TOD of the FTM_2 frame and the TOA of the ACK2 frame). The second device D2 receives the FTM_3 frame at time t_{c2}, and may capture its timestamp as time t_{c2}. The second device D2 may respond by transmitting a third acknowledgement (ACK3) frame to the first device D1 at time t_{c3}.

Upon receiving the FTM_3 frame at time t_{c2}, the second device D2 has timing information for times t_{b1}, t_{b2}, t_{b3}, and t_{b4} that correspond to the TOD of the FTM_2 frame transmitted from the first device D1, the TOA of the FTM_2 frame received at the second device D2, the TOD of the ACK2 frame transmitted from the second device D2, and the TOA of the ACK2 frame received at the first device D1, respectively. Thereafter, the second device D2 may determine a second RTT value as RTT₂=(t_{b4}−t_{b3})+(t_{b2}−t_{b1}). The ranging operation 400 may continue for any number of subsequent FTM and ACK frame exchanges between the first device D1 and the second device D2, for example, where the first device D1 embeds the timestamps of a given FTM and ACK frame exchange into a subsequent FTM frame transmitted to the second device D2.

Wireless ranging operations may be performed using frames transmitted as orthogonal frequency-division multiplexing (OFDM) symbols. The accuracy of RTT estimates may be proportional to the number of tones (such as the number of OFDM sub-carriers) used to transmit the ranging frames. In some aspects, while a legacy frame may be transmitted on a 20 MHz-wide channel using 52 tones, a high-throughput (HT) frame or a very high-throughput (VHT) frame may be transmitted on a 20 MHz-wide channel using 56 tones, and a high-efficiency (HE) frame may be transmitted on a 20 MHz-wide channel using 242 tones. An extremely high-throughput (EHT) frame may also be transmitted on a 20 MHz-wide channel. Thus, for a given frequency bandwidth or channel width, HT, VHT, and HE (and EHT) frames use more tones than non-HT frames, and may therefore provide more accurate channel estimates and RTT values than non-HT frames. The accuracy of RTT values may also be proportional to the frequency bandwidth upon which the measurement frames are transmitted between ranging devices, for example, such that frames transmitted using relatively high frequency bandwidths may result in more accurate RTT values than frames transmitted using relatively low frequency bandwidths.

Although the IEEE 802.11REVmc standards specify that FTM frames and ACK frames (such as the FTM_1 frame, the ACK1 frame, and the FTM_2 frame of FIG. 4) may be transmitted using the legacy format, the HT format, or the VHT format, the MCS to be used for transmitting the FTM and ACK frames is not specified for different frame formats. As discussed, ranging operations performed using FTM and ACK frames transmitted using non-legacy frame formats may be more accurate than ranging operations performed using FTM and ACK frames transmitted using legacy frame formats. Ranging accuracy may also be increased by transmitting the FTM frames and the ACK frames using the same non-legacy frame format.

Aspects of the present disclosure may allow wireless devices to announce or negotiate the frame format used to transmit FTM and ACK frames during a ranging operation, the MCS to be used for transmitting the FTM and ACK frames during the ranging operation, or both. In some implementations, a wireless device may announce an MCS table adopted by one or more IEEE 802.11 standards for transmitting frames during FTM protocol ranging operations. In other implementations, the wireless device may announce a proprietary or non-standard MCS table for transmitting frames during FTM protocol ranging operations, and may negotiate the selection of a particular proprietary or non-standard MCS to be used for transmitting the frames during FTM protocol ranging operations.

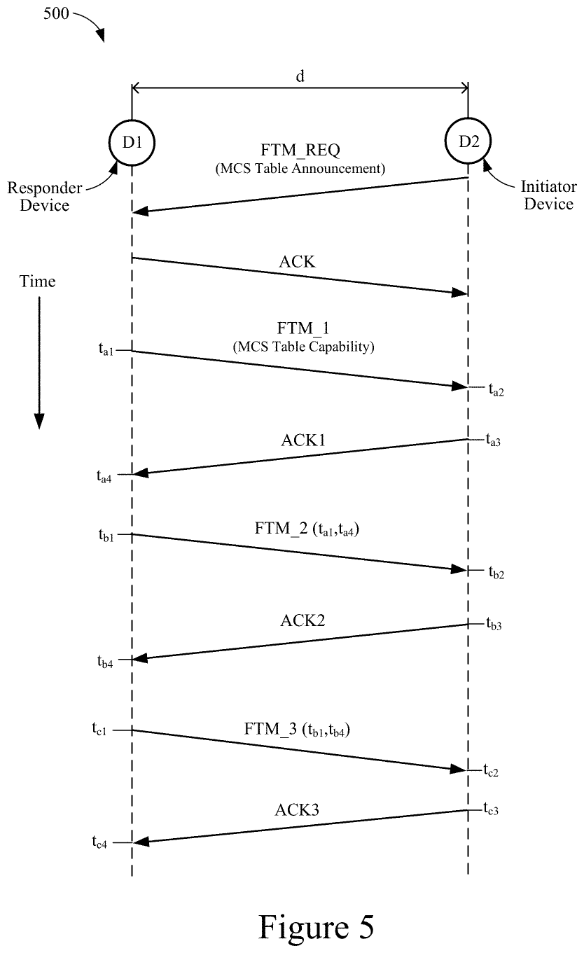

FIG. 5 shows a signal diagram of an example ranging operation 500. The example ranging operation 500 may be performed between the first device D1 and the second device D2. The first device D1 and the second device D2 each may be, for example, an access point (such as the AP 110 of FIG. 1 or the AP 200 of FIG. 2), a station (such as one of the STAs 120a-120i of FIG. 1 or the STA 300 of FIG. 3), or another suitable wireless device. For the example of FIG. 5, the second device D2 requests the ranging operation 500 and may be referred to as the initiator device; the first device D1 responds to the request from the second device D2 and may be referred to as the responder device.

The second device D2 may request or initiate the ranging operation 500 by transmitting an FTM_REQ frame to the first device D1. The FTM_REQ frame may include a request for the first device D1 to capture timestamps (such as TOA information of frames received by the first device D1 and TOD information of frames transmitted from the first device D1), may include a request for the first device D1 to estimate angle information of frames transmitted from the second device D2, or both. The FTM_REQ frame may also include information indicating a modulation and coding scheme (MCS) table to be used by the second device D2 to transmit non-legacy acknowledgement (ACK) frames to the first device D1 during the ranging operation 500.

In some implementations, the FTM_REQ frame may include an announcement element to announce the MCS table to be used by the second device D2.

The announcement element, which may be an information element (IE) or a vendor-specific information element (VSIE), may indicate that the second device D2 is to transmit legacy ACK frames during a first FTM burst of the ranging operation 500, and is to transmit non-legacy ACK frames during subsequent FTM bursts of the ranging operation 500. In some implementations, the announcement element may include a capability field and an optional MCS table field. The capability field may indicate whether the MCS table to be used by the second device D2 is defined by a wireless communication standard or is a non-standardized MCS table. In some aspects, the capability field may also include the non-standardized MCS table. In other implementations, the capability field may indicate whether the second device D2 supports MCS tables defined by the IEEE 802.11 standards or supports non-standardized MCS tables, and may also include the non-standardized MCS tables.

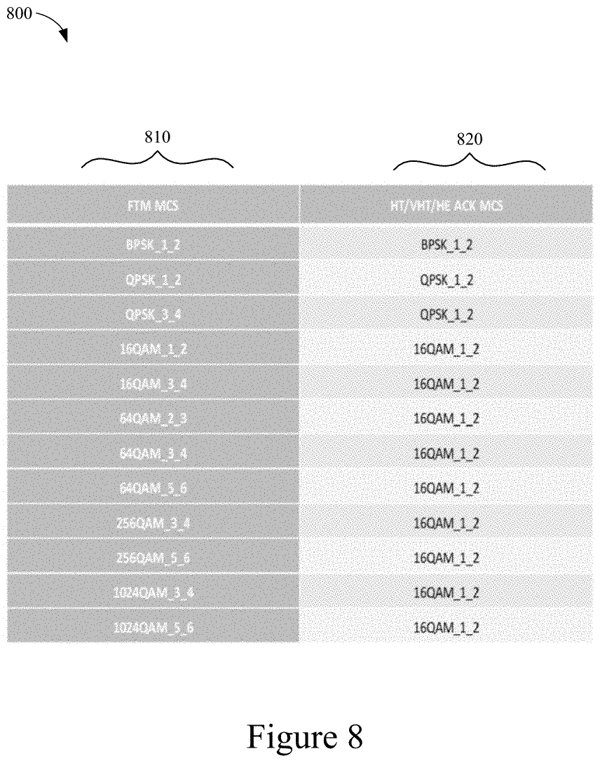

The MCS table field may include a plurality of MCS tables to be used by the second device D2 when transmitting ACK frames to the first device D1. In some implementations, each of the plurality of MCS tables may correspond to a respective one of a plurality of different ACK frame formats. The plurality of different ACK frame formats may include one or more of a high-throughput (HT) ACK frame, a very high-throughput (VHT) ACK frame, a high-efficiency (HE) ACK frame, or an extremely high-throughput (EHT) ACK frame. In addition, or in the alternative, each of the plurality of MCS tables may include a plurality of MCS values each based on a corresponding MCS used by the responder device to transmit FTM frames during the ranging operation 500, for example, as described with respect to FIG. 8.

The first device D1 receives the FTM_REQ frame, and may acknowledge the requested ranging operation 500 by transmitting an acknowledgement (ACK) frame to the second device D2. The ACK frame may indicate a number of capabilities of the first device D1 (such as whether the first device D1 is capable of capturing timestamps, capable of transmitting in a requested frame format and bandwidth, and so on), and may accept a number of the ranging parameters requested by the second device D2.

At time tₐ₁, the first device D1 transmits a first FTM (FTM_1) frame to the second device D2, and may capture the TOD of the FTM_1 frame as time tₐ₁. The FTM_1 frame may include an indication of whether the first device D1 is capable of supporting the MCS table to be used or proposed by the second device D2. In some implementations, the indication may be based on whether the first device D1 is capable of supporting the MCS table to be used or proposed by the second device D2. In addition, or in the alternative, the indication may be based, at least in part, on whether the first device D1 is capable of supporting the MCS table without reducing ranging accuracy by more than an amount. For example, although in some aspects the first device D1 may be able to receive and decode an ACK frame transmitted using a selected MCS, the first device D1 may expect an MCS that is different from the selected MCS (even though the selected MCS may have been indicated to the first device D1). Because the length of the ACK frame may be derived from the MCS used to transmit the ACK frame, differences between the selected MCS and the expected MCS may result in packet length errors. These packet length errors may cause errors in TOA values calculated by the first device D1, which in turn may lead to errors in RTT values estimated by one or both of the devices D1-D2. In some implementations, the first device D1 may use differences between the estimated RTT values and a set of known RTT values to determine whether ranging accuracy decreases by more than the amount when the second device D2 uses the proposed MCS table to transmit ACK frames to the first device D1.

For another example, the first device D1 may need to remove latencies introduced by its receiving path from captured TOA timestamps of received ACK frames to determine adjusted TOA values that correctly indicate the times at which the ACK frames were received by the first device D1. Because these latencies may be based at least in part on the MCS used to transmit the ACK frames, it is important for the first device D1 to use the correct MCS when determining these latencies. Otherwise, the latencies determined by the first device D1 may be incorrect, which may lead to errors in the determined TOA values and thus to errors in RTT values estimated by one or both of the devices D1-D2.

In some implementations, the FTM_1 frame may include a capability element indicating whether the first device D1 is capable of supporting an MCS table defined by a wireless communication standard or is capable of supporting a non-standardized MCS table. The capability element, which may be an information element (IE) or a vendor-specific information element (VSIE), may also indicate whether the first device D1 supports an MCS table proposed by the second device D2.

The second device D2 receives the FTM_1 frame at time tₐ₂, and may capture the TOA of the FTM_1 frame as time tₐ₂. The second device D2 responds by transmitting a first acknowledgement (ACK1) frame to the first device D1 at time tₐ₃, and may capture the TOD of the ACK1 frame as time tₐ₃. The first device D1 receives the ACK1 frame at time tₐ₄, and may capture the TOA of the ACK1 frame as time tₐ₄. At time t_{b1}, the first device D1 transmits (to the second device D2) an FTM_2 frame that includes timing information indicative of timestamps captured at times tₐ₁ and tₐ₄ (such as the TOD of the FTM_1 frame and the TOA of the ACK1 frame). The second device D2 receives the FTM_2 frame at time t_{b2}, and may capture its timestamp as time t_{b2}.

Upon receiving the FTM_2 frame at time t_{b2}, the second device D2 has timestamp values for times tₐ₁, tₐ₂, tₐ₃, and tₐ₄ that correspond to the TOD of the FTM_1 frame transmitted from the first device D1, the TOA of the FTM_1 frame received at the second device D2, the TOD of the ACK1 frame transmitted from the second device D2, and the TOA of the ACK1 frame received at the first device D1, respectively. Thereafter, the second device D2 may determine a first RTT value as RTT₁=(tₐ₄−tₐ₃)+(tₐ₂−tₐ₁).

At time t_{b3}, the first device D1 may transmit a second acknowledgement (ACK2) frame to the second device D2 (such as to acknowledge reception of the FTM_2 frame). The second device D2 receives the ACK2 frame at time t_{b4}, and may record the TOA of the ACK2 frame as time t_{b4}. At time t_{c1}, the second device D2 transmits (to the first device D1) a third FTM (FTM_3) frame that includes the timestamps captured at times t_{b1} and t_{b4} (such as the TOD of the FTM_2 frame and the TOA of the ACK2 frame). The first device D1 receives the FTM_3 frame at time t_{c2}, and may capture its timestamp as time t_{c2}. The first device D1 may respond by transmitting a third acknowledgement (ACK3) frame to the second device D2 at time t_{c3}.

FIG. 6A shows a flow chart depicting an example ranging operation 600. The example ranging operation 600 may be performed between any suitable wireless devices (such as the AP 110 of FIG. 1, the AP 200 of FIG. 2, the STAs 120a-120i of FIG. 1, or the STA 300 of FIG. 3), and may correspond to the ranging operation 500 shown in FIG. 5. For purposes of discussion herein, the ranging operation 600 of FIG. 6A is performed by the initiator device of an FTM protocol exchange (such as by the second device D2 of FIG. 5).

The initiator device may transmit, to the responder device, information indicating a modulation and coding scheme (MCS) table for transmitting non-legacy ACK frames to the responder device during the ranging operation (601). In some implementations, the initiator device may provide the MCS table in an FTM request frame (such as the FTM_REQ frame of FIG. 5) transmitted to the responder device. In some aspects, the FTM request frame may include an announcement element including the MCS table and a number of capabilities of the initiator device. In some implementations, the announcement element may include a plurality of MCS tables each corresponding to a respective one of a plurality of different ACK frame formats. In some aspects, the plurality of different ACK frame formats may include one or more of a high-throughput (HT) ACK frame, a very high-throughput (VHT) ACK frame, a high-efficiency (HE) ACK frame, or an extremely high-throughput (EHT) ACK frame. The announcement element, which may be an information element (IE) or a vendor-specific information element (VSIE), may include a capability field indicating whether the MCS table to be used by the initiator device is defined by a wireless communication standard or is a non-standardized MCS table.

In other implementations, the initiator device may provide the MCS table in Probe Requests, Probe Responses, Association Requests, Association Responses, TDLS Setup Requests, TDLS Setup Responses, Neighbor-Aware Network (NAN) Data Requests, NAN Data Responses, or any suitable frame to announce or otherwise provide the MCS table to be used for transmitting non-legacy ACK frames to the responder device.

The initiator device may receive a ranging frame including an indication of whether the responder device is capable of supporting the MCS table (602). In some implementations, information indicating whether the responder device is capable of supporting the MCS table announced by the initiator device may be included within a first FTM frame (such as the FTM_1 frame of FIG. 5) during an exchange of measurement frames between the initiator device and the responder device. In some aspects, the ranging frame may be a first fine timing measurement (FTM) frame including a capability element indicating whether the responder device is capable of supporting the MCS table defined by a wireless communication standard or is capable of supporting a non-standardized MCS table (such as proposed by the initiator device). The capability element may be an IE or a VSIE.

In other implementations, information indicating whether the responder device is capable of supporting the MCS table announced by the initiator device may be provided within Probe Requests, Probe Responses, Association Requests, Association Responses, TDLS Setup Requests, TDLS Setup Responses, Neighbor-Aware Network (NAN) Data Requests, NAN Data Responses, or any other suitable frame. In addition, or in the alternative, the indication may be based, at least in part, on whether the responder device is capable of supporting the MCS table without reducing ranging accuracy by more than an amount.

The initiator device may transmit to the responder device an ACK frame using an MCS that is based on the capability of the responder device to support the MCS table (603). In some implementations, the initiator device and the responder device may exchange measurement frames according to the FTM protocol, as described with respect to FIG. 6B. In other implementations, the initiator device and the responder device may exchange measurement frames (or other frames) according to another suitable ranging protocol.

FIG. 6B shows a flow chart depicting an example operation 610 for exchanging measurement frames during a ranging operation. The example operation 610 may be performed between any suitable wireless devices (such as the AP 110 of FIG. 1, the AP 200 of FIG. 2, the STAs 120a-120i of FIG. 1, or the STA 300 of FIG. 3), and may correspond to the ranging operation 500 shown in FIG. 5. For purposes of discussion herein, the operation 610 of FIG. 6B is performed by the initiator device of an FTM protocol exchange (such as by the second device D2 of FIG. 5).

The initiator device may receive, from the responder device, a first fine timing measurement (FTM) frame (611). The initiator device may determine the TOA of the first FTM frame, and the responder device may determine the TOD of the first FTM frame. The first FTM frame may include information indicating whether the responder device is capable of supporting the MCS table announced by the initiator device for transmitting non-legacy ACK frames during the exchange of measurement frames. In some implementations, the first FTM frame may include a capability element (such as an IE or a VSIE) indicating whether the responder device is capable of supporting an MCS table defined by a wireless communication standard or is capable of supporting a non-standardized MCS table proposed by the initiator device. In addition, or in the alternative, the indication contained in the capability element may be based, at least in part, on whether the responder device is capable of supporting either the standardized MCS table or the non-standardized MCS table without reducing ranging accuracy by more than an amount. In this manner, the initiator device and the responder device may negotiate and agree that the initiator device will use the non-standardized MCS table for transmitting non-legacy ACK frames during the exchange of measurement frames between each other, for example, rather than use the standardized MCS table.

The initiator device may transmit, to the responder device, an ACK frame responsive to the first FTM frame (612). The initiator device may determine the TOD of the ACK frame, and the responder device may determine the TOA of the ACK frame. In some implementations, the initiator device may transmit the ACK frame using the MCS table previously provided to the responder device.

The initiator device may receive, from the responder device, a second FTM frame including timing information of the first FTM frame and the ACK frame (613). The timing information may include the TOD of the first FTM frame from the responder device and the TOA of the ACK frame at the responder device. In some implementations, the initiator device may use the timing information provided by the responder device, the determined TOA of the first FTM frame, and the determined TOD of the ACK frame to determine one or more RTT values indicative of a distance between the initiator device and the responder device. In addition, or in the alternative, the initiator device and the responder device may exchange additional measurement frames during one or more subsequent FTM bursts.

FIG. 7A shows a flow chart depicting another example ranging operation 700. The example ranging operation 700 may be performed between any suitable wireless devices (such as the AP 110 of FIG. 1, the AP 200 of FIG. 2, the STAs 120a-120i of FIG. 1, or the STA 300 of FIG. 3), and may correspond to the ranging operation 500 shown in FIG. 5. For purposes of discussion herein, the ranging operation 700 of FIG. 7A is performed by the responder device of an FTM protocol exchange (such as by the first device D1 of FIG. 5).

The responder device may receive, from the initiator device, information indicating an MCS table for transmitting non-legacy ACK frames during the ranging operation (701). In some implementations, the responder device may receive the MCS table in an FTM request frame (such as the FTM_REQ frame of FIG. 5) transmitted by the initiator device. In some aspects, the FTM request frame may include an announcement element including the MCS table and a number of capabilities of the initiator device. In some implementations, the announcement element may include a plurality of MCS tables corresponding to a respective one of a plurality of different ACK frame formats. The plurality of different ACK frame formats may include one or more of a high-throughput (HT) ACK frame, a very high-throughput (VHT) ACK frame, a high-efficiency (HE) ACK frame, or an extremely high-throughput (EHT) ACK frame. The announcement element, which may be an IE or a VSIE, may also include a capability field indicating whether the MCS table announced by the initiator device is defined by a wireless communication standard or is a non-standardized MCS table. In other implementations, the responder device may receive the MCS table in Probe Requests, Probe Responses, Association Requests, Association Responses, TDLS Setup Requests, TDLS Setup Responses, Neighbor-Aware Network (NAN) Data Requests, NAN Data Responses, or any other suitable frame.

The responder device may transmit, to the initiator device, a ranging frame including an indication of whether the responder device is capable of supporting the MCS table announced by the initiator device (702). In some implementations, information indicating whether the responder device is capable of supporting the MCS table announced by the initiator device may be transmitted to the initiator device in a first FTM frame (such as the FTM_1 frame of FIG. 5). In some aspects, the ranging frame may be the first FTM frame and may include a capability element indicating whether the responder device is capable of supporting the MCS table defined by a wireless communication standard or is capable of supporting a non-standardized MCS table (such as the non-standardized MCS table proposed by the initiator device in the FTM_REQ frame).

In other implementations, information indicating whether the responder device is capable of supporting the MCS table announced by the initiator device may be provided within Probe Requests, Probe Responses, Association Requests, Association Responses, TDLS Setup Requests, TDLS Setup Responses, Neighbor-Aware Network (NAN) Data Requests, NAN Data Responses, or any other suitable frame. In addition, or in the alternative, the indication may be based, at least in part, on whether the responder device is capable of supporting the MCS table without reducing ranging accuracy by more than an amount.

The responder device may receive, from the initiator device, an ACK frame transmitted using an MCS that is based on the capability of the responder device to support the MCS table (703). In some implementations, the initiator device and the responder device may exchange measurement frames according to the FTM protocol, as described with respect to FIG. 7B. In other implementations, the initiator device and the responder device may exchange measurement frames according to another suitable ranging protocol.

FIG. 7B shows a flow chart depicting an example operation 710 for exchanging measurement frames during a ranging operation. The example operation 710 may be performed between any suitable wireless devices (such as the AP 110 of FIG. 1, the AP 200 of FIG. 2, the STAs 120a-120i of FIG. 1, or the STA 300 of FIG. 3), and may correspond to the ranging operation 500 shown in FIG. 5. For purposes of discussion herein, the operation 710 of FIG. 7B is performed by the responder device of an FTM protocol exchange (such as by the first device D1 of FIG. 5).

The responder device may transmit, to the initiator device, a first FTM frame (711). The responder device may determine the TOD of the first FTM frame, and the initiator device may determine the TOA of the first FTM frame. The first FTM frame may include information indicating whether the responder device is capable of supporting the MCS table announced by the initiator device for transmitting ACK frames during the exchange of measurement frames. In some implementations, the first FTM frame may include a capability element (such as an IE or a VSIE) indicating whether the responder device is capable of supporting an MCS table defined by a wireless communication standard or is capable of supporting a non-standardized MCS table (such as the MCS table provided by the initiator device). In some aspects, the initiator device may select either the standardized MCS table or the non-standardized MCS table for transmitting non-legacy ACK frames based on an indication that the responder device is capable of supporting both the standardized MCS table and the non-standardized MCS table. In addition, or in the alternative, the indication contained in the capability element may be based, at least in part, on whether the responder device is capable of supporting either the standardized MCS table or the non-standardize MCS table without reducing ranging accuracy by more than an amount. In this manner, the initiator device and the responder device may negotiate and agree that the initiator device will use the non-standardized MCS table for transmitting non-legacy ACK frames during the exchange of measurement frames, for example, rather than use the standardized MCS table.

The responder device may receive, from the initiator device, an ACK frame responsive to the first FTM frame (712). The responder device may determine the TOA of the ACK frame, and the initiator device may determine the TOD of the ACK frame. In some implementations, the initiator device may transmit the ACK frame using the MCS table provided to the responder device. In other implementations, the initiator device may transmit the ACK frame using the MCS table negotiated with the responder device.

The responder device may transmit, to the initiator device, a second FTM frame including timing information of the first FTM frame and the ACK frame (713). The timing information may include the TOD of the first FTM frame from the responder device and the TOA of the ACK frame at the responder device. In some implementations, the initiator device may use the timing information provided by the responder device, the determined TOA of the first FTM frame, and the determined TOD of the ACK frame to determine one or more RTT values indicative of a distance between the initiator device and the responder device. In addition, or in the alternative, the initiator device and the responder device may exchange additional measurement frames during one or more subsequent FTM bursts.

FIG. 8 shows an example MCS Table 800. The MCS Table 800 includes a first column 810 indicating a number of MCS values that can be used by the responder device to transmit FTM frames during FTM protocol ranging operations, and includes a second column 820 indicating the corresponding MCS values that the initiator device will use to transmit non-legacy ACK frames during FTM protocol ranging operations. For one example, if the responder device uses an MCS=BPSK_1_2 to transmit FTM frames, then the initiator device will use BPSK_1_2 to transmit ACK frames. For another example, if the responder device uses either an MCS=QPSK_1_2 or an MCS=QPSK_2_3 to transmit FTM frames, then the initiator device will use QPSK_1_2 to transmit ACK frames. For yet another example, if the responder device uses either an MCS=16QAM_1_2, 16QAM_2_3, 16QAM_3_4, or 16QAM_5_6 to transmit FTM frames, then the initiator device will use 16QAM_1_2 to transmit ACK frames. Further, as shown in Table 8, the initiator device will use an MCS=16QAM_1_2 to transmit ACK frames when the responder device uses variations of 256QAM and 1024QAM modulation schemes.

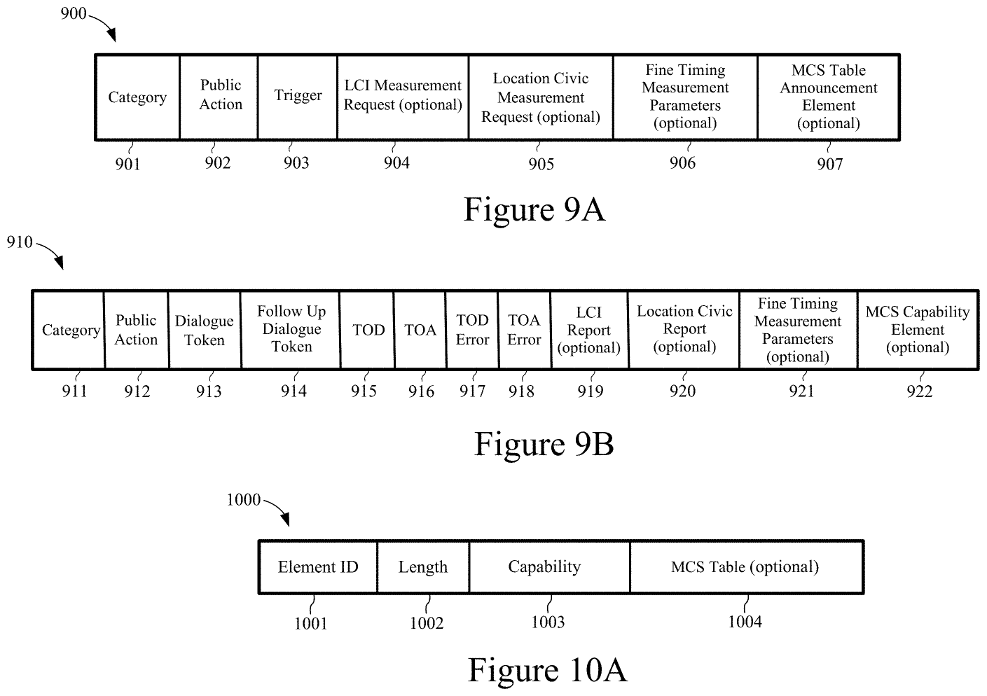

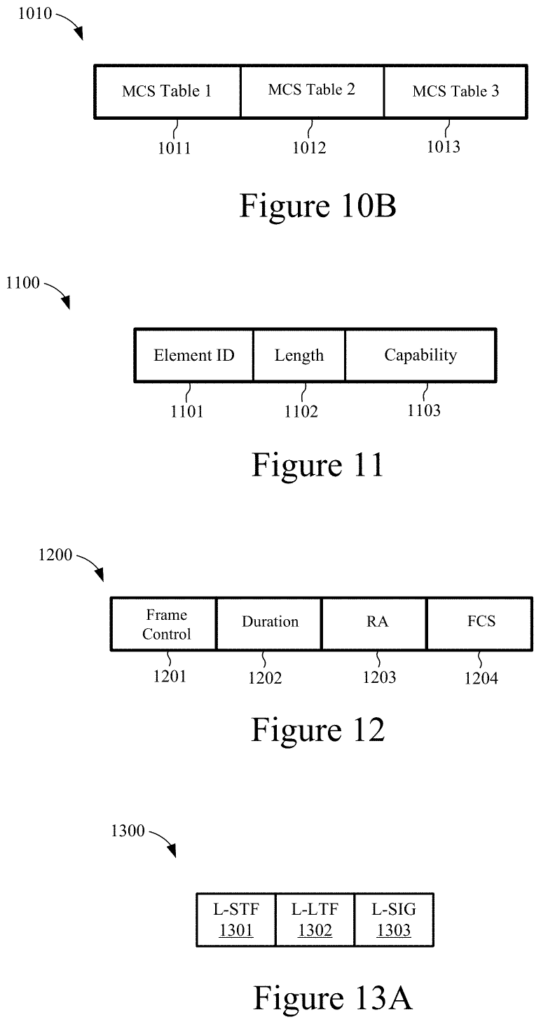

FIG. 9A shows an example FTM_REQ frame 900. The FTM_REQ frame 900 may be used in the example ranging operation 500 of FIG. 5. The FTM_REQ frame 900 may include a category field 901, a public action field 902, a trigger field 903, an optional location civic information (LCI) measurement request field 904, an optional location civic measurement request field 905, an optional FTM parameters field 906, and an optional MCS table announcement element 907. The fields 901-906 of the FTM_REQ frame 900 are well-known, and therefore are not discussed in detail herein. The MCS table announcement element 907 may include information indicating the MCS table for transmitting non-legacy ACK frames to the responder device during a ranging operation. In some implementations, the MCS table announcement element 907 may include additional information, as described with respect to FIG. 10A.

FIG. 9B shows an example FTM frame 910. The FTM frame 910 may be used in the ranging operation 500 of FIG. 5. The FTM frame 910 may include a category field 911, a public action field 912, a dialogue token field 913, a follow up dialog token field 914, a TOD field 915, a TOA field 916, a TOD error field 917, a TOA error field 918, an optional LCI report field 919, an optional location civic report field 920, an optional FTM parameters field 921, and an optional MCS capability element 922. The fields 911-921 of the FTM frame 910 are well-known, and therefore are not discussed in detail herein. In some implementations, a number of reserved bits in the TOD error field 917 or a number of reserved bits in the TOA error field 918 (or both) may be used to store an antenna mask. In addition, or in the alternative, the TOA field 916 may store a TOA error value determined by transmitting device (such as the second device D2 of FIG. 5) based on coherent channel combining operations or non-coherent channel combining operations.

The MCS capability element 922 may include information indicating whether the responder device is capable of supporting an MCS table defined by a wireless communication standard or is capable of supporting a non-standardized MCS table (such as proposed by the initiator device). In some implementations, the MCS apability element 922 may include additional information, as described with respect to FIG. 11.

FIG. 10A shows an example MCS Table Announcement Element 1000. The MCS Table Announcement Element 1000, which may be one implementation of the MCS Table Announcement Element 907 of FIG. 9A, may include an element ID field 1001, a length field 1002, a capability field 1003, and an optional MCS Table field 1004. In some implementations, the element ID field 1001 may include one byte, the length field 1002 may include one byte, the capability field 1003 may include one byte, and the MCS Table field 1004 may include a variable number of bytes (although in some other implementations, other field lengths may be used).

In some implementations, the MCS Table Announcement Element 1000 may be provided within FTM_REQ frames used for ranging operations performed according to the FTM protocol. In other implementations, the MCS Table Announcement Element 1000 may be provided in other suitable frames including (but not limited to) Beacon Frames, Probe Requests, Probe Responses, Association Requests, Association Responses, TDLS Setup Requests, TDLS Setup Responses, Neighbor-Aware Network (NAN) Data Requests, NAN Data Responses, or any suitable frame transmitted by a first device to announce an MCS table for use in transmitting ACK frames to a second device in a ranging operation.

The element ID field 1001 may store an element ID value indicating that the MCS Table Announcement Element 1000 includes information indicating the MCS table to be used by an initiator device to transmit non-legacy ACK frames during FTM ranging operations. The length field 1002 may store a value indicating a length (in bytes) of the capability field 1003 and the MCS Table field 1004.

The capability field 1003 may include information indicating the MCS table to be used by the initiator device to transmit non-legacy ACK frames to the responder device during an FTM protocol ranging operation, and whether the MCS table to be used by the initiator device is defined by a wireless communication standard or is a non-standardized MCS table. The capability field 1003 may also include information indicating whether the initiator device supports a number of MCS tables defined by a wireless communication standard or supports a number of non-standardized MCS tables. In addition, or in the alternative, the capability field 1003 may include information indicating whether the MCS Table Announcement Element 1000 includes a non-standardized MCS table proposed by the initiator device for an FTM protocol ranging operation. In some implementations, the capability field 1003 may include eight bits (bits b0-b7) indicating the following information:
bit b0: a value of 1 indicates that the initiator device supports the standard HT MCS table defined by the IEEE 802.11 standards, and a value of 0 indicates that the initiator device does not support the standard HT MCS table defined by the IEEE 802.11 standards;
bit b1: a value of 1 indicates that the HT MCS table used to generate the HT ACK frame is included in the MCS Table field 1004, and a value of 0 indicates that the HT MCS table is not included in the MCS Table field 1004;
bit b2: a value of 1 indicates that the initiator device supports the standard VHT MCS table defined by the IEEE 802.11 standards, and a value of 0 indicates that the initiator device does not support the standard VHT MCS table defined by the IEEE 802.11 standards;
bit b3: a value of 1 indicates that the VHT MCS table used to generate the VHT ACK frame is included in the MCS Table field 1004, and a value of 0 indicates that the VHT MCS table is not included in the MCS Table field 1004;
bit b4: a value of 1 indicates that the initiator device supports the standard HE MCS table defined by the IEEE 802.11 standards, and a value of 0 indicates that the initiator device does not support the standard HE MCS table defined by the IEEE 802.11 standards;
bit b5: a value of 1 indicates that the HE MCS table used to generate the HE ACK frame is included in the MCS Table field 1004, and a value of 0 indicates that the HE MCS table is not included in the MCS Table field 1004; and
bits b6-b7 are reserved.

The MCS Table field 1004 may include a plurality of MCS tables. In some implementations, each of the plurality of MCS tables may correspond to a respective one of a plurality of different ACK frame formats. In some aspects, the plurality of different ACK frame formats includes one or more of a high-throughput (HT) ACK frame, a very high-throughput (VHT) ACK frame, a high-efficiency (HE) ACK frame, or an extremely high-throughput (EHT) ACK frame.

FIG. 10B shows an example MCS Table field 1010. The MCS Table field 1010, which may be one implementation of the MCS Table field 1004 of FIG. 10A, is shown to include three MCS Tables 1011-1013. Each of the MCS Tables 1011-1013 may store a number of MCS values to be used by the initiator device to transmit ACK frames during a ranging operation based on corresponding MCS values used by the responder device to transmit FTM frames during the ranging operation. In some implementations, each of the MCS Tables 1011-1013 may include at least 21 bits (bits b0-b20) indicating the following information:
bit b0: a value of 1 indicates that the table is an HT MCS table, and a value of 0 indicates that the table is not an HT MCS table;
bit b1: a value of 1 indicates that the table is a VHT MCS table, and a value of 0 indicates that the table is not a VHT MCS table;
bit b2: a value of 1 indicates that the table is an HE MCS table, and a value of 0 indicates that the table is not an HE MCS table;
bits b0-b2: a value of “111” indicates that the corresponding MCS table is to be used by the initiator device to transmit ACK frames in any of the HT, VHT, and HE frame formats;
bit b3: a value of 1 indicates that the table is the last table contained in the MCS Table field 1004, and a value of 0 indicates that there is at least one additional table contained in the MCS Table field 1004;
bit b4-b7: indicate the MCS to be used by the initiator device based on the responder device using an MCS=MSC0 to transmit FTM frames;
bits b8-b11: indicate the MCS to be used by the initiator device based on the responder device using an MCS=MSC1 to transmit FTM frames, and so on, where:
bits b48-b51: indicate the MCS to be used by the initiator device based on the responder device using an MCS=MSC11 to transmit FTM frames; and
bits b52-63: reserved.

In some implementations, each of the above groups of 4 bits may indicate one of sixteen MCS values for transmitting non-legacy ACK frames during a ranging operation. In some aspects, a value of 000 indicates an MCS=MSC0, a value of 001 indicates an MCS=MSC1, a value of 010 indicates an MCS=MSC2, a value of 011 indicates an MCS=MSC3, a value of 100 indicates an MCS=MSC4, and so on.

FIG. 11 shows an example MCS Capability Element 1100. The MCS Capability Element 1100, which may be one implementation of the MCS Capability Element 922 of FIG. 9B, may include an element ID field 1101, a length field 1102, and a capability field 1103. In some implementations, the element ID field 1101 may include one byte, the length field 1102 may include one byte, and the capability field 1103 may include one byte (although in some other implementations, other field lengths may be used).

In some implementations, the MCS Capability Element 1100 may be provided within FTM_1 frames for ranging operations performed using the FTM protocol. In some other implementations, the MCS Capability Element 1100 may be provided in other suitable frames including (but not limited to) beacon frames, Probe Requests, Probe Responses, Association Requests, Association Responses, TDLS Setup Requests, TDLS Setup Responses, NAN Data Request, NAN Data Responses, or any suitable frame transmitted by the responder device.

The element ID field 1101 may store an element ID value indicating that the MCS Capability Element 1100 contains information indicating capabilities of a responder device to support MCS tables announced or proposed by an initiator device for an FTM protocol ranging operation. The length field 1102 may store a value indicating a length (in bytes) of the capability field 1103. The capability field 1103 may include information indicating whether the responder device supports MCS tables defined by a wireless communication protocol or supports non-standardized MCS tables.

In some implementations, the capability field 1103 may include eight bits (bits b0-b7) indicating the following information:
bit b0: a value of 1 indicates that the responder device supports the standard HT MCS table defined by the IEEE 802.11 standards, and a value of 0 indicates that the responder device does not support the standard HT MCS table defined by the IEEE 802.11 standards (or at least not without reducing ranging accuracy by more than an amount);
bit b1: a value of 1 indicates that the responder device supports the initiator device's non-standard HT MCS table, and a value of 0 indicates that the responder device does not support the initiator device's non-standard HT MCS table (or at least not without reducing ranging accuracy by more than an amount);
bit b2: a value of 1 indicates that the responder device supports the standard VHT MCS table defined by the IEEE 802.11 standards, and a value of 0 indicates that the responder device does not support the standard VHT MCS table defined by the IEEE 802.11 standards (or at least not without reducing ranging accuracy by more than an amount);
bit b3: a value of 1 indicates that the responder device supports the initiator device's non-standard VHT MCS table, and a value of 0 indicates that the responder device does not support the initiator device's non-standard VHT MCS table (or at least not without reducing ranging accuracy by more than an amount);
bit b4: a value of 1 indicates that the responder device supports the standard HE MCS table defined by the IEEE 802.11 standards, and a value of 0 indicates that the responder device does not support the standard HE MCS table defined by the IEEE 802.11 standards (or at least not without reducing ranging accuracy by more than an amount);
bit b5: a value of 1 indicates that the responder device supports the initiator device's non-standard HE MCS table, and a value of 0 indicates that the responder device does not support the initiator device's non-standard HE MCS table (or at least not without reducing ranging accuracy by more than an amount); and
bits b6-b7: reserved.

FIG. 12 shows an example acknowledgement (ACK) frame 1200. In some aspects, the ACK frame 1200 may be used as the ACK frames in the example ranging operation 500 of FIG. 5. The example ACK frame 1200 may include a 2-byte frame control field 1201, a 2-byte duration field 1202, a 6-byte receiver address (RA) field 1203, and a 4-byte frame control sequence (FCS) field 1204. Although not shown in FIG. 12 for simplicity, the frame control field 1201 may include a 2-bit frame Type field and a 4-bit Sub type field that together may store information indicating that the example frame 1200 of FIG. 12 is an ACK frame. For other embodiments, the field lengths of the example ACK frame 1200 may be of other suitable values. The duration field 1202 stores a value indicating a length of the ACK frame 1200, the RA field 1203 stores an address identifying the recipient of the ACK frame, and the FCS field 1204 stores a frame control sequence.

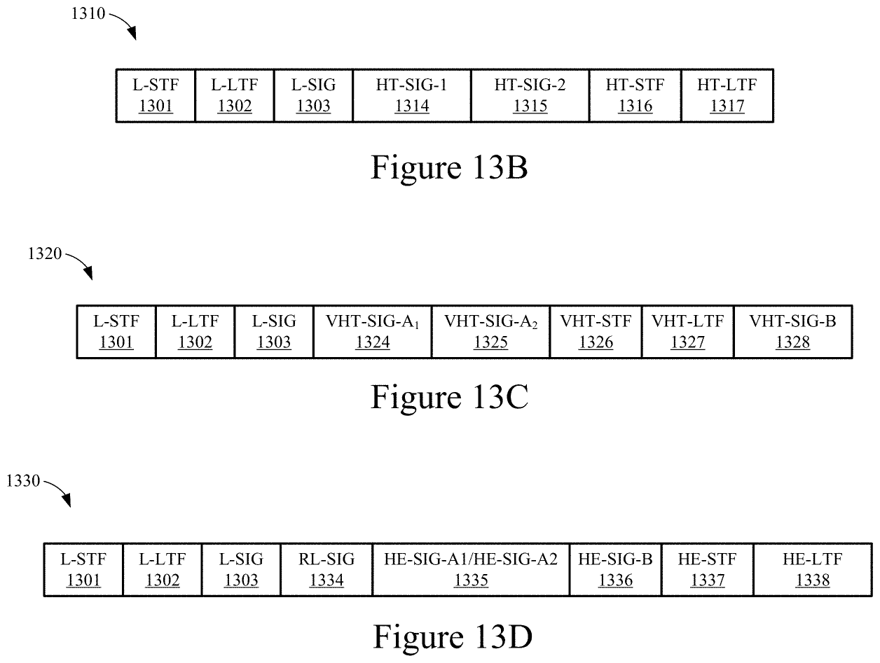

FIG. 13A shows an example preamble 1300 of a non-HT packet (such as a legacy packet). The non-HT packet, which is not shown for simplicity, may be used to transmit measurement frames (such as FTM frames and ACK frames) during ranging operations (such as the example ranging operation 500 of FIG. 5). In some implementations, the legacy preamble 1300 may be pre-pended to the ACK frame 1200 of FIG. 12 for wireless transmission to another wireless device. The legacy preamble 1300, which may be compliant with the IEEE 802.11a/g standards, is shown to include a Legacy Short Training Field (L-STF) 1301, a Legacy Long Training Field (L-LTF) field 1302, and a Legacy Signal (L-SIG) field 1303. A receiving device may use information contained in the L-STF 1301 for coarse frequency estimation, automatic gain control, and timing recovery, and may use information contained in the L-LTF 1302 for fine frequency estimation as well as channel estimation and fine timing recovery. Information contained in the L-SIG field 1303 may be used to convey modulation and coding information.

FIG. 13B shows an example preamble 1310 of an HT packet. The HT packet, which is not shown for simplicity, may be used to transmit measurement frames during ranging operations (such as the example ranging operation 500 of FIG. 5). The preamble 1310, which may be compliant with the IEEE 802.11n standards, is shown to include the L-STF 1301, L-LTF 1302, and L-SIG field 1303 of FIG. 13A, as well as a first HT Signal (HT-SIG-1) field 1314, a second HT Signal (HT-SIG-2) field 1315, an HT Short Training Field (HT-STF) 1316, and an HT Long Training Field (HT-LTF) 1317. The HT-SIG fields 1314-1315 may be used to convey modulation and coding information, as well as the channel bandwidths, for HT transmissions. Information contained in the HT-STF 1316 may be used to improve automatic gain control estimates for MIMO communications, and information contained in the HT-LTF 1317 may be used to estimate MIMO channel conditions.

FIG. 13C shows an example preamble 1320 of a VHT packet. The VHT packet, which is not shown for simplicity, may be used to transmit measurement frames during ranging operations (such as the example ranging operation 500 of FIG. 5). The preamble 1320, which may be compliant with the IEEE 802.11ac standards, is shown to include the L-STF 1301, L-LTF 1302, and L-SIG field 1303 of FIG. 13A, as well as a set of VHT Signal-A (VHT-SIG-A) fields 1324 and 1325, a VHT Short Training Field (VHT-STF) 1326, a VHT Long Training Field (VHT-LTF) 1327, and a VHT Signal B (VHT-SIG-B) field 1328. The VHT-SIG-A fields 1324-1325 may be used to convey modulation and coding information, channel bandwidths, SU-MIMO information, MU-MIMO information, beamforming information, and other suitable information for VHT transmissions. Information contained in the VHT-STF 1326 may be used to improve automatic gain control estimates for SU-MIMO and MU_MIMO communications, and information contained in the VHT-LTF 1327 may be used to estimate various MIMO channel conditions. The VHT-SIG-B field 1328 may include additional SU-MIMO and MU-MIMO information including, for example, user-specific information and the number of spatial streams associated with a given frame transmission.

FIG. 13D shows an example preamble 1330 of an HE packet. The HE packet, which is not shown for simplicity, may be used to transmit measurement frames during ranging operations (such as the example ranging operation 500 of FIG. 5). The preamble 1330, which may be compliant with the IEEE 802.11ax standards, is shown to include the L-STF 1301, L-LTF 1302, and L-SIG field 1303 of FIG. 13A, as well as a Repeated Legacy Signal (RL-SIG) field 1334, a set of HE Signal-A (HE-SIG-A1/HE-SIG-A2) fields 1335, an HE Signal B (HE-SIG-B) field 1336, an HE Short Training Field (HE-STF) 1337, and an HE Long Training Field (HE-LTF) 1338. The HE-SIG-A1 and HE-SIG-A2 fields 1335 may include parameters such as an indicated bandwidth, a payload guard interval (GI), a coding type, a number of spatial streams (Nsts), a space-time block coding (STBC), beamforming information, and so on. Information contained in the HE-STF 1337 may be used to improve automatic gain control estimates for SU-MIMO and MU_MIMO communications, and information contained in the HE-LTF 1338 may be used to estimate various MIMO channel conditions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of performing a ranging operation between an initiator device and a responder device, the method performed by the initiator device and comprising:
transmitting information indicating a modulation and coding scheme (MCS) table for transmitting non-legacy acknowledgement (ACK) frames to the responder device during the ranging operation;
receiving, from the responder device, a ranging frame including an indication of whether the responder device is capable of supporting the MCS table; and
transmitting to the responder device an ACK frame using an MCS that is based on the capability of the responder device to support the MCS table.

2. The method of claim 1, wherein the MCS table is transmitted to the responder device in a fine timing measurement (FTM) request frame.

3. The method of claim 2, wherein the FTM request frame indicates that the initiator device is to transmit legacy ACK frames during a first FTM burst, and is to transmit non-legacy ACK frames during subsequent FTM bursts.

4. The method of claim 2, wherein the FTM request frame includes an announcement element comprising a capability field indicating whether the MCS table is defined by a wireless communication standard or is a non-standardized MCS table.

5. The method of claim 4, wherein the capability field further indicates whether the announcement element includes the non-standardized MCS table.

6. The method of claim 4, wherein the announcement element further comprises a plurality of MCS tables, wherein each of the plurality of MCS tables corresponds to a respective one of a plurality of different ACK frame formats, and wherein the plurality of different ACK frame formats includes one or more of a high-throughput (HT) ACK frame, a very high-throughput (VHT) ACK frame, a high-efficiency (HE) ACK frame, or an extremely high-throughput (EHT) ACK frame.

7. The method of claim 1, wherein the MCS table includes a plurality of MCS values each based on a corresponding MCS used by the responder device to transmit fine timing measurement (FTM) frames during the ranging operation.

8. The method of claim 1, wherein the ranging frame comprises a first fine timing measurement (FTM) frame including a capability element indicating whether the responder device is capable of supporting an MCS table defined by a wireless communication standard or is capable of supporting a non-standardized MCS table.

9. The method of claim 1, wherein the ranging frame comprises a first fine timing measurement (FTM) frame, and the method further comprises:
receiving, from the responder device, a second FTM frame including timing information of the first FTM frame and the ACK frame.

10. A method of performing a ranging operation between an initiator device and a responder device, the method performed by the responder device and comprising:
receiving, from the initiator device, information indicating a modulation and coding scheme (MCS) table for transmitting non-legacy acknowledgement (ACK) frames during the ranging operation;
transmitting, to the initiator device, a ranging frame including an indication of whether the responder device is capable of supporting the MCS table; and
receiving, from the initiator device, an ACK frame transmitted using an MCS that is based on the capability of the responder device to support the MCS table.

11. The method of claim 10, wherein the MCS table is received from the initiator device in a fine timing measurement (FTM) request frame.

12. The method of claim 11, wherein the FTM request frame indicates that the initiator device is to transmit legacy ACK frames during a first FTM burst, and is to transmit non-legacy ACK frames during subsequent FTM bursts.

13. The method of claim 11, wherein the FTM request frame includes an announcement element comprising a capability field indicating whether the MCS table is defined by a wireless communication standard or is a non-standardized MCS table.

14. The method of claim 13, wherein the capability field further indicates whether the announcement element includes the non-standardized MCS table.

15. The method of claim 13, wherein the announcement element further comprises a plurality of MCS tables, wherein each of the plurality of MCS tables corresponds to a respective one of a plurality of different ACK frame formats, and wherein the plurality of different ACK frame formats includes one or more of a high-throughput (HT) ACK frame, a very high-throughput (VHT) ACK frame, a high-efficiency (HE) ACK frame, or an extremely high-throughput (EHT) ACK frame.

16. The method of claim 10, wherein the MCS table includes a plurality of MCS values each based on a corresponding MCS used by the responder device to transmit fine timing measurement (FTM) frames during the ranging operation.

17. The method of claim 10, wherein the ranging frame comprises a first fine timing measurement (FTM) frame including a capability element indicating whether the responder device is capable of supporting an MCS table defined by a wireless communication standard or is capable of supporting a non-standardized MCS table.

18. The method of claim 10, wherein the ranging frame comprises a first fine timing measurement (FTM) frame, and the method further comprises:
transmitting, to the initiator device, a second FTM frame including timing information of the first FTM frame and the ACK frame.

19. An apparatus for performing a ranging operation with a responder device, the apparatus comprising:
one or more processors; and
a memory comprising instructions that, when executed by the one or more processors, cause the apparatus to:
transmit information indicating a modulation and coding scheme (MCS) table for transmitting non-legacy acknowledgement (ACK) frames to the responder device during the ranging operation;
receive, from the responder device, a ranging frame including an indication of whether the responder device is capable of supporting the MCS table; and
transmit to the responder device an ACK frame using an MCS that is based on the capability of the responder device to support the MCS table.

20. The apparatus of claim 19, wherein the MCS table is transmitted to the responder device in a fine timing measurement (FTM) request frame.

21. The apparatus of claim 20, wherein the FTM request frame indicates that the apparatus is to transmit legacy ACK frames during a first FTM burst, and is to transmit non-legacy ACK frames during subsequent FTM bursts.

22. The apparatus of claim 20, wherein the FTM request frame includes an announcement element comprising a capability field indicating whether the MCS table is defined by a wireless communication standard or is a non-standardized MCS table.

23. The apparatus of claim 19, wherein the ranging frame comprises a first fine timing measurement (FTM) frame including a capability element indicating whether the apparatus is capable of supporting an MCS table defined by a wireless communication standard or is capable of supporting a non-standardized MCS table.

24. The apparatus of claim 19, wherein the ranging frame comprises a first fine timing measurement (FTM) frame, and execution of the instructions further causes the apparatus to:
receive, from the responder device, a second FTM frame including timing information of the first FTM frame and the ACK frame.

25. An apparatus for performing a ranging operation with an initiator device, the apparatus comprising:
one or more processors; and
a memory comprising instructions that, when executed by the one or more processors, cause the apparatus to:
receive, from the initiator device, information indicating a modulation and coding scheme (MCS) table for transmitting non-legacy acknowledgement (ACK) frames during the ranging operation;
transmit, to the initiator device, a ranging frame including an indication of whether the apparatus is capable of supporting the MCS table; and
receive, from the initiator device, an ACK frame transmitted using an MCS that is based on the capability of the apparatus to support the MCS table.

26. The apparatus of claim 25, wherein the MCS table is received from the initiator device in a fine timing measurement (FTM) request frame.

27. The apparatus of claim 26, wherein the FTM request frame indicates that the initiator device is to transmit legacy ACK frames during a first FTM burst, and is to transmit non-legacy ACK frames during subsequent FTM bursts.

28. The apparatus of claim 26, wherein the FTM request frame includes an announcement element comprising a capability field indicating whether the MCS table is defined by a wireless communication standard or is a non-standardized MCS table.

29. The apparatus of claim 25, wherein the ranging frame comprises a first fine timing measurement (FTM) frame including a capability element indicating whether the apparatus is capable of supporting an MCS table defined by a wireless communication standard or is capable of supporting a non-standardized MCS table.

30. The apparatus of claim 25, wherein the ranging frame comprises a first fine timing measurement (FTM) frame, and execution of the instructions further causes the apparatus to:
transmit, to the initiator device, a second FTM frame including timing information of the first FTM frame and the ACK frame.
